(19) United States
(12) Patent Application Publication
(10) Pub. No.: US 2004/0201985 A1
(43) Pub. Date: Oct. 14, 2004

(54) Automatic contrast compensation apparatus for an organic light-emitting diode display

(76) Inventors: Nien-Hui Kung, Toufen Township (TW); Jing-Meng Liu, Hsinchu (TW); Der-Jiunn Wang, Hsinchu (TW); Chao-Hsuan Chuang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/751,425

(22) Filed: Jan. 6, 2004

(30) Foreign Application Priority Data
Apr. 8, 2003 (TW) 092205514

(51) Int. Cl. F21L 4/00

(52) U.S. Cl. 362/183; 362/276

(57) ABSTRACT

An automatic contrast compensation apparatus for an OLED display comprises a photo detector, an OLED driver, a safety clamping circuit, and a solar cell. When the intensity of environmental light increased, the photo detector sends a signal to the OLED driver to increase the brightness of the OLED display and for which, the solar cell provides the extra power for the OLED driver to improve the displaying performance of the OLED display in a power-saving manner. The safety clamping circuit prevents the OLED driver from over-current from the solar cell.

### FIELD OF THE INVENTION

The present invention relates generally to an organic light-emitting diode (OLED) and more particularly, to a power-saving automatic contrast compensation apparatus for an OLED display.

### BACKGROUND OF THE INVENTION

OLED display is gradually popular due to its high brightness and contrast. However, the contrast of an OLED display would decrease when environmental light is strong. To maintain high contrast, the brightness of the OLED display needs to be adjusted passively by users, which causes increasing of the power consumption of the OLED display and therefore shortens the life of battery. For portable products, such as mobile phone and PDA, it is not convenient for users.

It is therefore desired a power-saving apparatus for adjusting the display performance of an OLED display.

### SUMMARY OF THE INVENTION

An object of the present invention is to provide a power-saving automatic contrast compensation apparatus for an OLED display, and according to the present invention, which comprises a photo detector, an OLED driver, a safety clamping circuit, and a solar cell. When the intensity of environmental light increases, the photo detector sends a signal to the OLED driver to increase the brightness of the OLED display for improving its displaying performance. Simultaneously, the solar cell provides the extra power for the OLED driver for saving power. The safety clamping circuit limits the current provided by the solar cell to the OLED driver for over-current protection.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows the first embodiment of the present invention;

FIG. 2 shows the second embodiment of the present invention; and

FIG. 3 shows the third embodiment of the present invention.

### DETAILED DESCRIPTION OF THE INVENTION

### First Embodiment

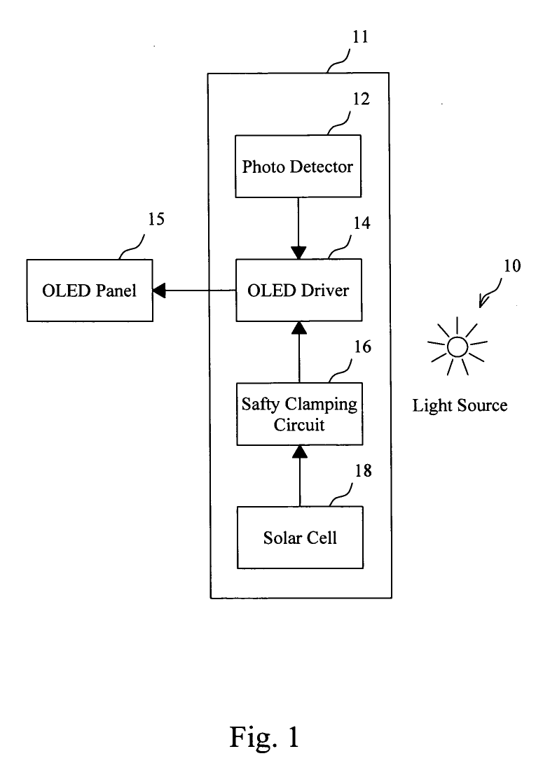

FIG. 1 shows a preferred embodiment of the present invention, in which an automatic contrast compensation apparatus 11 comprises a photo detector 12, an OLED driver 14, a safety clamping circuit 16, and a solar cell 18. When the intensity of light source 10 increases, the photo detector 12 detects the enhanced light intensity and sends a signal to the OLED driver 14 to increase the brightness of OLED panel 15. Simultaneously, the solar cell 18 provides the extra energy resulted from the increased brightness of the OLED panel 15 by the OLED driver 14. The safety clamping circuit 16 can avoid the current from the solar cell 18 too much to damage system in blaze.

### Second Embodiment

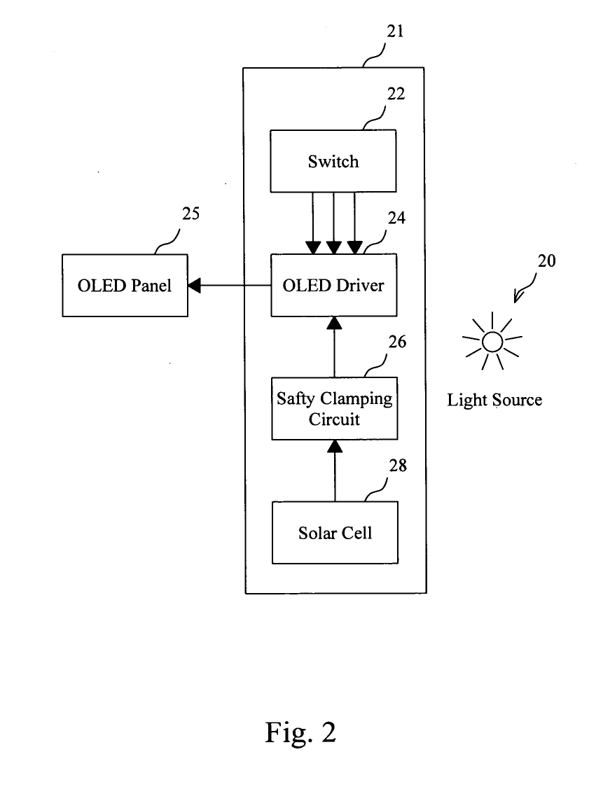

FIG. 2 shows another embodiment of the present invention by an automatic contrast compensation apparatus 21 that comprises a switch 22, an OLED driver 24, a safety clamping circuit 26, and a solar cell 28. When the intensity of light source 20 increases, the switch 22 is actively or passively turned on to send a signal to the OLED driver 24 to increase the brightness of OLED panel 25. Simultaneously, the solar cell 28 provides for the power consumption to increase the brightness of the OLED panel 25 by the OLED driver 24. The safety clamping circuit 16 can avoid over-current from the solar cell 18 to damage system in blaze.

### Third Embodiment

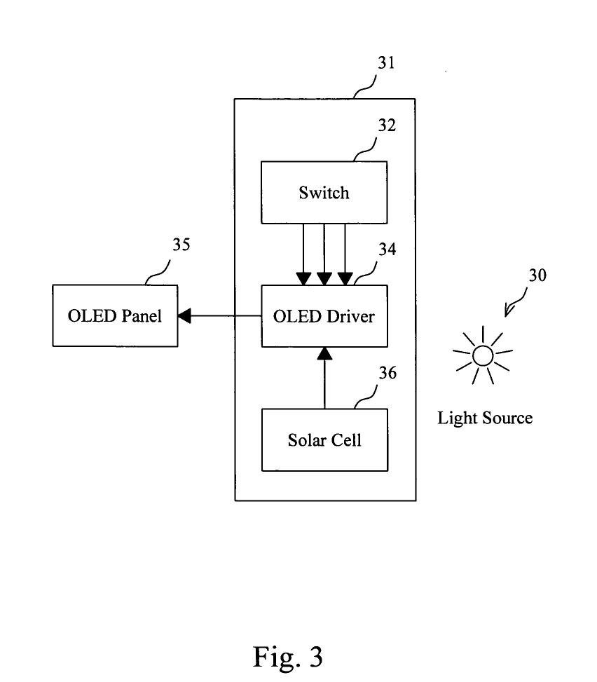

FIG. 3 shows a further embodiment of the present invention. A power-saving automatic contrast compensation apparatus 31 comprises a switch 32, an OLED driver 34, and a solar cell 36. When the intensity of light source 30 increases, the switch 32 is actively or passively turned on to send a signal to the OLED driver 34 to increase the brightness of OLED panel 35. Simultaneously, the solar cell 36 provides the power for the increased brightness of the OLED panel 35 to the OLED diver 34.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An automatic contrast compensation apparatus for an OLED display, comprising:
a photo detector for detecting environmental light intensity;
an OLED driver for receiving a signal from said photo detector to increase brightness of said OLED display when said environmental light intensity increases;
a solar cell for providing power for said OLED driver to increase brightness of said OLED display; and
a safety clamping circuit connected between said solar cell and OLED driver for over-current protection of said OLED driver in blaze.

2. An automatic contrast compensation apparatus for an OLED display, comprising:
an OLED driver for driving said OLED display;
a solar cell for providing power for said OLED driver to increase brightness of said OLED display when environmental light intensity increases;
a safety clamping circuit connected between said solar cell and OLED driver for over-current protection of said OLED driver in blaze; and
a switch for controlling said OLED driver to increase brightness of said OLED display.

3. An automatic contrast compensation apparatus for an OLED display, comprising:
an OLED driver for driving said OLED display;
a solar cell for providing power for said OLED driver to increase brightness of said OLED display when environmental light intensity increases;
a switch for controlling said OLED driver to increase brightness of said OLED display.
